(19) United States
(12) Patent Application Publication
(10) Pub. No.: US 2009/0213499 A1
(43) Pub. Date: Aug. 27, 2009

(54) RAMP MECHANISM AND MAGNETIC DISK APPARATUS

(75) Inventors: Jinzou Yamamoto, Kawasaki (JP); Hiroshi Kondou, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/246,299

(22) Filed: Oct. 6, 2008

(30) Foreign Application Priority Data
Feb. 22, 2008 (JP) 2008-41339

(51) Int. Cl. G11B 5/54

(52) U.S. Cl. 360/250

(57) ABSTRACT

A hard disk drive is provided with a ramp mechanism at the side of the disks for holding head sliders when the disks do not rotate. The ramp mechanism includes a ramp unit at least partially opposed to an outer edge of each disk medium. A roller provided in the ramp unit rotatably contacts the outer edge of the disk medium when the outer edge of the disk medium deflects with respect to its rotation axis.

### BACKGROUND OF THE INVENTION

1. Field of the Invention

The embodiments discussed herein are directed to a ramp mechanism and a magnetic disk apparatus. More particularly, the embodiments discussed herein relate to a ramp mechanism for holding a head slider at a position distanced from disk media and a magnetic disk apparatus having the ramp mechanism.

2. Description of the Related Art

Conventionally, a hard disk drive (hereinafter referred to as a “HDD”) reads data from and writes data onto disk media such as magnetic disks, with read/write heads provided on head sliders. The head sliders fly over the disk media with a lift of airflow generated by rotations of the disk media. The heads of the HDD described above are not designed to contact the disk media while the disk media are not rotating. For that reason, the HDD is provided with a ramp mechanism at the side of the disk for holding the head sliders when the disks do not rotate.

The ramp mechanism is provided with holding planes for retracting the head sliders therebetween, and slopes for guiding the head sliders through the holding planes between the surfaces of the disk media and the ramp mechanism. Typically, the slopes hang over the disk medium.

When a shock or a vibration is given on the HDD externally, the disk media mounted on the spindle jolt, and are deflected by the shock. Additionally, the disk media vibrate attributed to an airflow generated by rotation of the disks. The vibrations are called fluttering. Where the disk media deflect or warp during rotation at high speed, the disk media may make contact with the ramp mechanism.

To solve the problem described above, a technique has been developed in which outer edges of disks are placed in contact with stepped protrusions provided at portions of the ramp member where the outer edges of the disks may contact actively.

[Patent literature 1] Japanese Laid-open Patent Publication No. 2002-279744
[Patent literature 2] Japanese Laid-open Patent Publication No. 2006-12405

Furthermore, another technique reduces dust particles caused by friction with a ramp by contacting recording surfaces of magnetic disks instead of contacting the outer edges of the disks that are more vulnerable to wear than the recording surfaces. The ramp has escape spaces provided where the outer edges of magnetic disks might otherwise contact the ramp.

[Patent literature 3] Japanese Laid-open Patent Publication No. 2006-323939

Although the techniques disclosed in the patent literatures 1 through 3 reduce dust particles or provide protection for specific portions of the disks by making the specific portions of the disks such as the outer edges or the recording surfaces contact the ramp when the disks deflect, it is inevitable that the disks contact with the ramp under certain circumstances. Where the disks contact the ramp, the ramp wears, the dust particles disperse in the HDD, contaminating the surfaces of the read/write heads or damaging the disks, disturbing data writing and reading.

The ramp mechanism and the magnetic disk apparatus according to an embodiment of the present invention solves the problems described above. An object of embodiments of the present invention is to provide a ramp mechanism for reducing dust particles caused by the friction between the disk media and the ramp mechanism. Further, another object of the present invention is to provide a magnetic disk apparatus for accurate data recording and reproducing.

### SUMMARY

In accordance with an aspect of embodiments, a ramp mechanism includes a ramp unit at least partially opposed to an outer edge of a disk medium that rotates about a rotation axis at a specific interval, holding a head slider that is flyable over the disk medium at a distanced position. A roller in the ramp unit rotatably contacts the outer edge of the disk medium where the outer edge of the disk medium deflects with respect to the rotation axis horizontally.

### BRIEF DESCRIPTION OF THE DRAWINGS

FIG. 1 illustrates an internal structure of the HDD;

FIG. 2 is a perspective view of the ramp mechanism;

FIG. 3 is a sectional view of the ramp mechanism shown in FIG. 2 along line A-A;

FIG. 4 illustrates behaviors of the rotation mechanism shown in FIG. 3;

FIG. 5 illustrates one of the variations of the rotation mechanism; and

FIG. 6 illustrates another variation of the rotation mechanism.

### DETAILED DESCRIPTION OF THE EMBODIMENTS

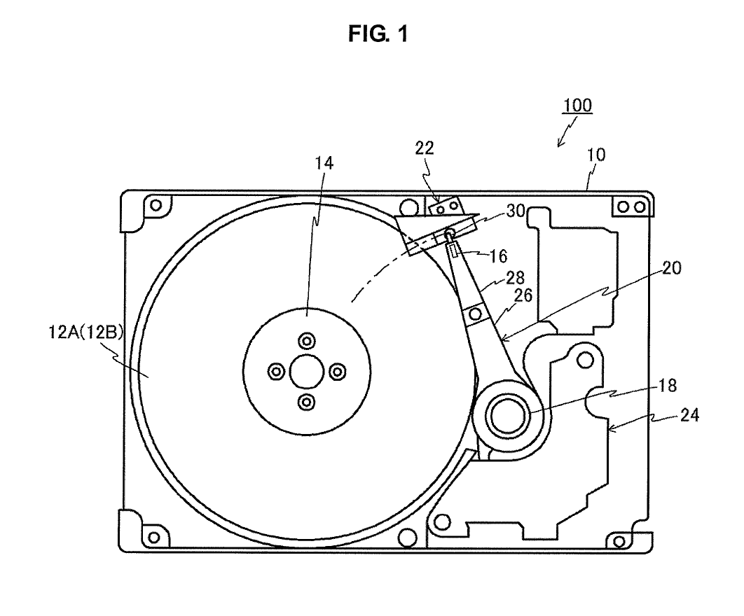

With reference to FIGS. 1 through 4, the embodiment of the present invention will be disclosed.

FIG. 1 illustrates the internal structure of the magnetic disk apparatus according to the embodiment of the present invention, a HDD 100. The HDD 100 has: a box-shaped enclosure 10; magnetic disks 12A and 12B that are housed in the enclosure 10, located parallel to each other; a spindle motor 14; a head slider 16; a head stack assembly (HAS) 20; and a ramp mechanism 22, etc as shown in FIG. 1. The enclosure 10 has a base and a top cover. The top cover is not seen in FIG. 1.

The magnetic disks 12A and 12B have a recording surface on both sides respectively, rotated simultaneously by the spindle mortar 14 at high speed, i.e., in a range of 10,000 rpm to 15,000 rpm. The magnetic disks 12A and 12B, have a substrate made of aluminum or glass; and on both sides of the substrate there are formed an underlayer made of Cr alloy; a magnetic layer made of CoCrPt alloy; a protective layer made of diamond-like carbon (DLC) film etc; and a lubricant layer made of organic liquid lubricant having a main chain of perfluoropolyether and end groups such as hydroxyl (—OH) and a benzene ring.

The head slider 16 has, for instance, a read/write head having a write element for writing data onto the magnetic disks 12A or 12B by utilizing a magnetic field generated by a laminate coil pattern, and a read element such as a giant magnetoresistence (GMR) element or a tunnel magnetoresistance element for reading data from the magnetic disks 12A or 12B by utilizing change in resistance of a spin-valve film or a tunnel junction film. Although only one head slider 16 is seen in FIG. 1, however, total of four head sliders 16 are provided at regular intervals on the HAS 20 in parallel over and under the magnetic disks 12A and 12B.

The HAS 20 is rotatably supported by a spindle 18, rotated by a voice coil motor 24 about the spindle 18, following an arc drawn with the dashed line shown in FIG. 1. The HAS 20 has four suspensions 28 each having a head arm 26 on their tips respectively. On each tip of the suspensions 28, the head slider 16 is attached respectively. The head arms 26 are made of stainless plates by pressing or aluminum by extrusion.

Each of the head sliders is supported with a gimbal spring not seen in FIG. 1 on one side of the tip of the suspension 28. Each head slider 16 is pressured toward its surface of the magnetic disks 12A and 12B by its suspension 28. However, a buoyant force generated by an airflow caused by rotation of the magnetic disks 12A and 12B is also applied to the head slider 16. By the balance between the lift and the pressure, the head sliders 16 fly with relatively high rigidity while the magnetic disks 12A and 12B are rotating. The spindle 18 drives the head arms 26 to position the read/write head attached thereon to a target track while the head slider is lifted.

The HAS 20 having the structure described above is retracted at the determined resting position shown in FIG. 1 when the magnetic disks 12A and 12B do not rotate. The tips of the HAS 20 are located outside of the outer edges of the magnetic disks 12A and 12B when the HAS 20 is retracted in the resting position. The retraction of the HAS 20 is implemented by driving the head arms 26 as described before.

A ramp mechanism 22 is situated on an extension of the arc of the tip of the suspension 28, more specifically, lift tabs 30 provided on the tips as shown in FIG. 1, holding the lift tabs 30 when the head arms 26 are drawn to the resting position.

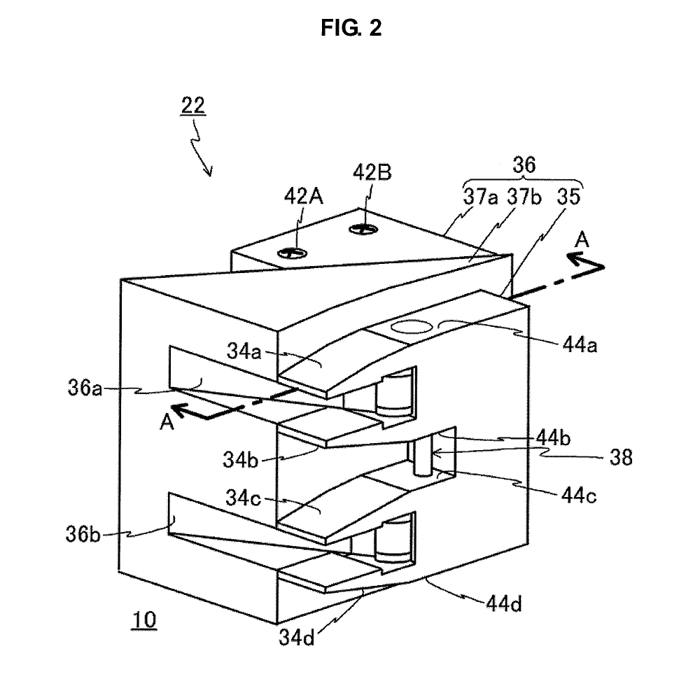

The structure of the ramp mechanism 22 will be disclosed with reference to FIGS. 2 through 4 in detail.

The ramp mechanism 22 has, as shown in FIG. 2: a ramp mechanism main body 36 that is secured with screws 42A and 42B in the enclosure 10 as a ramp unit; and a rotation mechanism 38 that is incorporated into the ramp mechanism main frame 36 as a rolling unit.

The ramp mechanism main body 36 made of, for instance, rigid plastic, has: a fixed part 37a that is fixed in the enclosure 10 with the screws; a main frame 37b in a substantially triangular shape in a top view, attached to the fixed part 37a integrally; and a guide-holder 35 having a substantially U-shape, fixed to the main frame 37b.

The guide-holder 35 has horizontal planes 44a through 44d and slopes 34a through 34d that serve as slide planes. In the recesses formed by the horizontal planes 44a through 44d, the lift tabs 30 provided on the tips of the suspensions 28 respectively are held when the magnetic disks 12A and 12B do not rotate. Therefore, the horizontal planes 44a through 44d are referred to as holding planes 44a through 44d hereinafter. The slide planes 34a through 34d are guides for sliding the lift tabs 30 between the holding planes 44a through 44d and the recording surfaces of the magnetic disks 12A and 12B smoothly.

The ramp mechanism main body 36 has two recesses 36a and 36b formed on the front edge of the main body 36 horizontally at specific intervals. The recesses 36a and 36b have circular shapes following the shape of the outer edges of the magnetic disks 12A and 12B, intruding between the outer edges of the magnetic disks 12A and 12B partially as shown in FIG. 1.

When the magnetic disks 12A and 12B stop after completing data writing or reading with the read/write head, the voice coil motor 24 drives the HAS 20 including the head arms 26 to the resting position described above. When the head sliders 16 reach the outer edges of the magnetic disks 12A and 12B, the lift tabs 30 contact the slide planes 34a through 34d, sliding along the slide planes 34a through 34d. As the lift tabs 30 move along the slide planes 34a through 34d, the head sliders 16 are distanced from the magnetic disks 12A and 12B. Finally, the lift tabs 30 are drawn into the recesses formed by the holding planes 44a through 44d, respectively, and the HAS 20 rests at the resting position.

When writing data onto or reading data from the magnetic disks 12A and 12B, the voice coil motor 24 drives the HAS 20 in a reverse manner, from the holding planes 44a through 44d to the slide planes 34a through 34d, then to the surfaces of the magnetic disks 12A and 12B when the rotating magnetic disk 12A and 12B enter a steady state. Thus, each head slider 16 is opposed to its respective recording surface of the magnetic disks 12A and 12B. Because the lift attributed to the airflow generated by the rotations of the magnetic disks 12A and 12B is imposed on the head sliders 16 upon coming into operation, the head sliders 16 are lifted over the recording surfaces of the magnetic disks 12A and 12B after leaving the slide planes 34a through 34d.

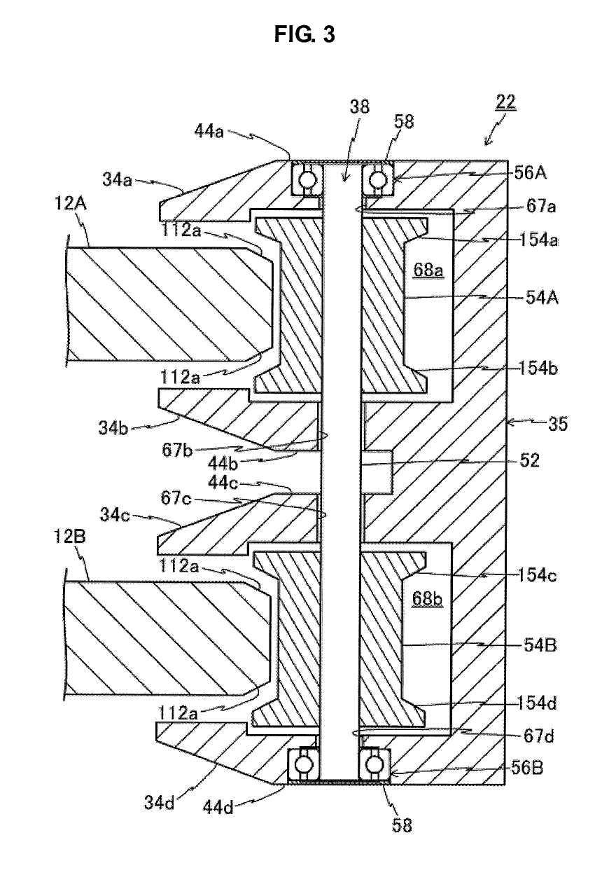

As shown in FIG. 2, the rotation mechanism 38 is incorporated into the guide-holder 35 that is a part of the ramp mechanism main body 36. As seen in FIG. 3, the sectional view of the ramp mechanism shown in FIG. 2 along line A-A, the rotation mechanism 38 has: a shaft 52 that extends in a vertical direction; rollers 54A and 54B fixed onto the shaft 52; and ball bearings 56A and 56B supporting the shaft 52 rotatably.

The shaft 52 penetrates through the guide-holder 35 in a noncontact manner with through-holes 67a, 67b, 67c, and 67d formed in the guide-holder 35, for instance, creating about 0.1 mm clearances between the shaft and the through-holes.

The rollers 54A and 54B are in substantially cylindrical shapes, made of plastic, metal or ceramic, etc, having tapered portions 154a, 154b, 154c and 154d around their tops and bottoms. The angle of the inclines of the tapered portions 154a, 154b, 154c and 154d with respect to the rotation axis is substantially the same angle of the inclines of the tapered edges 112a of the magnetic disks 12A and 12B in a rotation axis. The rollers 54A and 54B are housed in bores 68a and 68b formed in the guide-holder 35.

The ball bearings 56A and 56B may be minuscule, for instance, 2 mm in diameter. The inner ring of the ball bearing 56A is fixed on the top of the shaft 52 and the outer ring of the ball bearing 56A is fixed to the guide-holder 35. The inner ring of the ball bearing 56B is fixed on the bottom of the shaft 52 and the outer ring of the ball bearing 56B is fixed to the guide-holder 35. Covers 58 are provided on the ball bearing 56A and under the ball bearing 56B even with the top and under surfaces of the guide-holder 35. The covers 58 prevent scattering of the lubricant in the ball bearings in the HDD 100 with the wind pressure caused by the rotation of the ball bearings.

In this embodiment, the organic liquid lubricant used for the lubricant layer of the magnetic disks 12A and 12B having the main chain of perfluoropolyether and the end groups such as hydroxyl (—OH) and the benzene ring is used for the ball bearings 56A and 56B. The lubricant having the property described above may keep harmful effects minimum whereas the lubricant used for the ball bearings may be scattered and attach on the recording surfaces of the magnetic disks 12A and 12B. The ball bearings 56A and 56B may be, alternatively, cylindrical roller bearings or other types of roller bearings.

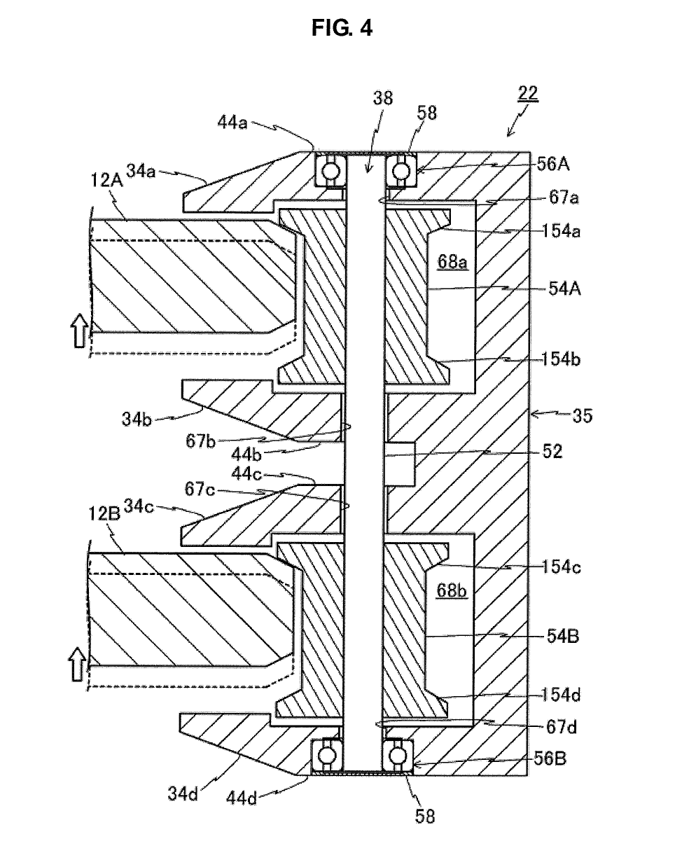

Owing to the structure of the rotation mechanism 38 described above, the magnetic disks 12A and 12B do not contact the ramp mechanism main body 36, more specifically the guide-holder 35, when the outer edges of the magnetic disks 12A and 12B deflect or warp upward by a shock on the HDD 100 given from the outside, as shown in FIG. 4, because the tapered portions 154a and 154c of the rollers 54A and 54B catch the deflected edges of the magnetic disks 12A and 12B and rotate in the reverse direction of the disk rotation when the disks bump into the rollers. Similarly, if the magnetic disks 12A and 12B deflect downward, the outer edges of the disks contact the tapered portions 154b and 154b of the rollers 54A and 54B. Therefore, the magnetic disks 12A and 12B do not directly contact the guide-holder 35.

Accordingly, the ramp mechanism 22 in this embodiment may prevent friction between the ramp mechanism main body 36, more specifically the guide-holder 35, and the magnetic disks 12A and 12B. Thus, dust particles caused by friction between the disks and the ramp may be prevented. If the outer edges of the magnetic disks 12A and 12B contact the rollers 54A and 54B, the rollers 54A and 54B absorb the impact of the magnetic disks 12A and 12B by rotating in the reverse direction of the disk rotations together with the shaft 52. Therefore, friction between the magnetic disks 12A and 12B and the rollers 54A and 54B may be curbed to the negligible level. Hence, the ramp mechanism in this embodiment may reduce the dust particles caused by contact friction between the rollers 54A and 54B and the disks effectively.

Again, since the HDD 100 in this embodiment may reduce the dust particles caused by friction between the magnetic disks 12A and 12B and the ramp mechanism 22 effectively, contamination on the read/write head and damage to the surfaces of the magnetic disks 12A and 12B attributed to the dust particles scattered in the HDD 100 may be reduced. Therefore, errors in data writing and reading may be reduced.

In this embodiment, the portions of the rollers 54A and 54B which contact the magnetic disks 12A and 12B are tapered at substantially the same angle of the tapered edges of the magnetic disks 12A and 12B. Thus, the magnetic disks 12A and 12B have line contacts with the tapered portions 154a through 154d. In comparison with point contacts, this may rotate the rollers 54A and 54B more effectively.

Moreover, the rotation mechanism 38 in this embodiment uses the same lubricant used for the lubricant layers of the magnetic disks 12A and 12B. Therefore, the possible contamination on the recording surfaces of the magnetic disks 12A and 12B caused by scattered lubricant may not impair the performance of the read/write head.

Furthermore, the two rollers 54A and 54B are fixed on the shaft 52 integrally in this embodiment, which enables the roller-shaft assembly to rotate all together where even one magnetic disk contacts at least one of the rollers. Thus, the number of components is fewer than providing a shaft to each roller together with ball bearings. Therefore, the ramp mechanism 22, by the extension to the HDD100 as a whole, may be reduced in size and weight. However, the present invention is not to be considered limited to what is described herein. A one-roller-on-one-shaft structure may be also applicable.

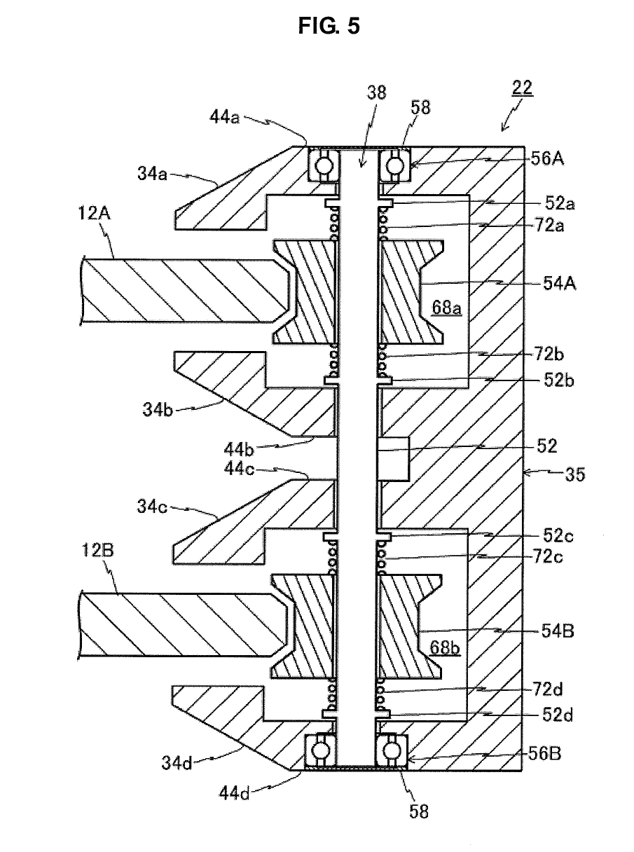

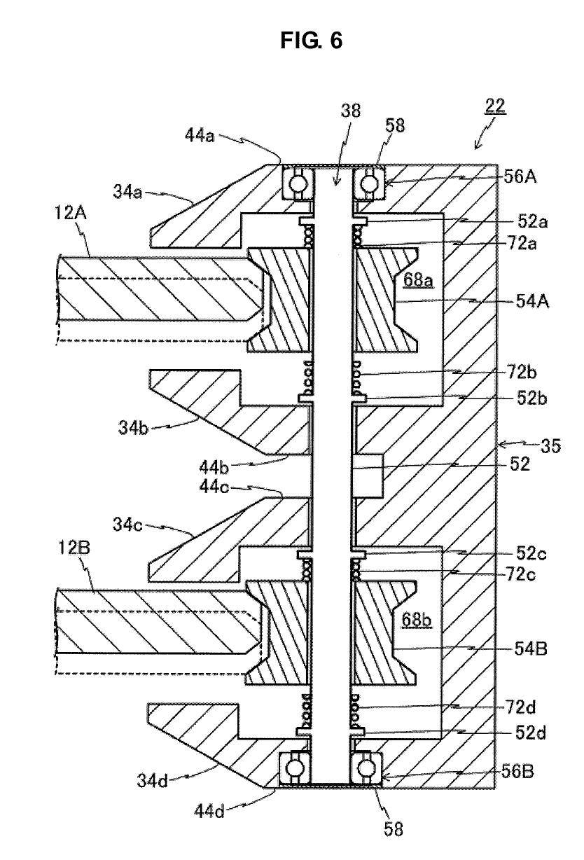

Alternatively, the rollers 54A and 54B and the shaft 52 may be designed as shown in FIG. 5 instead of the integral assembly of the rollers 54A and 54B and the shaft 52 in this embodiment. In FIG. 5, the rollers 54A and 54B are provided on the shaft 52 movably in a vertical direction only, and compression coil springs 72a, 72b, 72c and 72d may be provided between the rollers 54a and 54b and projections 52a, 52b, 52c and 52d formed on the shaft 52. This embodiment may produce an advantage similar to that of the structure described above. In addition, the rollers 54A and 54B incorporated in the rotation mechanism 38 are provided with the resilient members, namely, the compression coil springs, which transform resiliently if the rollers 54A and 54B move in the vertical direction on contacting the magnetic disks 12A and 12B, between the rollers 54A and 54B and the protrusions formed on the shaft 52 as described above as shown in FIG. 6. Thus, the compression coil springs 72a and 72b absorb the impact of the outer edges of the magnetic disks 12A and 12B on the rollers 54A and 54B in vertical direction by transforming elastically.

Alternatively, resilient members other than the compression coil springs may be provided between the rollers and the protrusions. The resilient members can transform by a specific compression and return to their original state on releasing the compression; or transform by a specific tension and return to their original state on releasing the tension. In brief, members made of gum or sponge may be applicable as the resilient members as well as extension coil springs and other types of springs.

In this embodiment, the rollers 54A and 54B are fixed onto the shaft 52 integrally and the rollers and the shaft rotate all together. However, the present invention is not to be considered limited to the embodiment described herein. For instance, the shaft 52 may be fixed in the guide-holder 35 and the rollers 54A and 54B may be supported on the shaft 52 rotatably. With this structure, a portion that rotates when contacting the magnetic disks 12A and 12B is reduced, and therefore noise generated by rotation is reduced. For the structure described above, the ball bearings may be provided between the shaft 52 and the rollers 54A and 54B, or lubricant may be applied between the shaft 52 and the rollers 54A and 54B. The lubricant applied to the bearings or applied between the shaft 52 and the rollers 54A and 54B may be the same lubricant used for the lubricant layers of the magnetic disks 12A and 12B in the embodiment.

In this embodiment, the HDD 100 has two magnetic disks. However, the magnetic disks mounted in the HDD 100 may be one or more than three. In this instance, rollers of the same number of the magnetic disks may be provided on one shaft or on a plurality of shafts. More specifically, where three magnetic disks are mounted in the HDD 100, three rollers may be provided on one shaft; two rollers may be provided on one of two shafts and one roller may be provided on the other shaft; or one roller may be provided on each of three shafts respectively.

In this embodiment, the rollers and the shaft are fabricated separately. If possible, the rollers and the shaft are integrally molded with a homogeneous material.

In this embodiment, the guide-holder 35 has the rotation mechanism 38 therein. However, the rotation mechanism 38 may be provided in the main frame 37b.

According to this embodiment, the disk media do not directly contact the ramp unit because of the rollers if the outer edges of the disk media deflect with respect to the rotation axis. What is more, since the rollers relieve the impact of the contact with disk media by rotating, significant friction between the disk media and the rollers may be avoided. Thus, the dust particles attributed to the friction with the disk media may be reduced effectively.

Since the dust particles are reduced, the soil on the read/write head or the damage caused by dust particles may be reduced. As a result, signal quality for writing and reading may be ensured, and losses of read signals due to damage on the disks may be prevented, and ultimately, reliability of the magnetic disk apparatus may be ensured.

This embodiment is a preferred embodiment of the present invention. However, many alternatives, modifications, and variation will occur in the scope of the present invention.

What is claimed is:

1. A ramp mechanism comprising:
a ramp unit at least partially opposed to an outer edge of a disk medium that rotates about a rotation axis at a specific interval, holding a head slider that is flyable over said disk medium at a distanced position; and
a roller provided in said ramp unit that rotatably contacts an outer edge of said disk medium when the outer edge of said disk medium deflects with respect to said rotation axis.

2. The ramp mechanism according to claim 1, wherein a portion of said roller with which the roller contacts with said disk medium is tapered with respect to said rotation axis.

3. The ramp mechanism according to claim 1, further comprising:
a resilient member that transforms resiliently where said roller moves with respect to said rotation axis vertically on contact with said disk medium.

4. The ramp mechanism according to claim 2, further comprising:
a resilient member that transforms resiliently where said roller moves with respect to said rotation axis vertically on contact with said disk medium.

5. The ramp mechanism according to claim 1, wherein at least a part of said roller is libricated.

6. The ramp mechanism according to claim 5, wherein said lubricant is made of a homogeneous material of lubricant used for a lubricant layer of said disk medium.

7. The ramp mechanism according to claim 2, wherein at least a part of said roller is lubricant.

8. The ramp mechanism according to claim 3, wherein at least a part of said roller is lubricated.

9. A magnetic disk apparatus according, comprising:
a magnetic disk medium rotating about a rotation axis;
a head slider having a head for data writing onto and reading from said magnetic disk medium; and
a ramp mechanism for holding said head slider at a position distanced from said magnetic disk medium;
wherein the ramp mechanism includes a ramp unit at least partially opposed to an outer edge of a disk medium that rotates about a rotation axis at a specific interval, holding a head slider that is flyable over said disk medium at a distanced position, and a roller provided in said ramp unit that rotatably contacts an outer edge of said disk medium when the outer edge of said disk medium deflects with respect to said rotation axis.
